(19) United States
(12) Patent Application Publication
(10) Pub. No.: US 2024/0070390 A1
(43) Pub. Date: Feb. 29, 2024

(54) GENERATING SUGGESTIONS USING EXTENDED REALITY

(71) Applicant: Micron Technology, Inc., Boise, ID (US)

(72) Inventors: Saideep TIKU, Folsom, CA (US); Poorna KALE, Folsom, CA (US)

(21) Appl. No.: 17/823,763

(22) Filed: Aug. 31, 2022

(51) Int. Cl. G06F 40/274; G06V 30/244; G06F 3/01; G06T 19/00

(52) U.S. Cl. CPC G06F 40/274; G06V 30/245; G06F 3/017; G06T 19/006

(57) ABSTRACT

In some implementations, an extended reality (XR) device may detect, using a scene captured by the XR device, text associated with a document, wherein the text associated with the document is within a field of view of the XR device. The XR device may determine one or more keywords of the text and a context associated with the text. The XR device may generate, using a language model, predicted text based on the one or more keywords of the text and the context associated with the text, wherein the predicted text is related to the text associated with the document. The XR device may provide, via an interface of the XR device, the predicted text as a visual overlay to the text associated with the document, wherein the predicted text is visually overlayed in proximity to the text associated with the document.

### TECHNICAL FIELD

The present disclosure generally relates to extended reality (XR) devices and, for example, generating suggestions using XR.

### BACKGROUND

Extended reality (XR) may blend a physical world (or real world) and a virtual world (or digital world) to create a more personalized, immersive visual experience. XR may encompass augmented reality (AR), mixed reality (MR), and virtual reality (VR). AR may provide an interactive experience of a physical-world environment, in which objects that reside in the physical world may be enhanced by computer-generated perceptual information. MR may merge physical and virtual worlds to produce new environments and visualizations, in which physical and digital objects may co-exist and interact in real time. VR may provide a fully virtual world without an intervention of the physical world. XR may be across multiple sensory modalities, including visual, auditory, haptic, somatosensory, and/or olfactory. XR may be useful across a wide variety of applications, such as gaming, healthcare, retail, customer service, and/or manufacturing.

### BRIEF DESCRIPTION OF THE DRAWINGS

FIGS. 1A-1B are diagrams of an example related to generating suggestions, such as predicted text, using extended reality (XR).

FIGS. 2-3 are diagrams of examples related to generating predicted text using XR.

FIGS. 4A-4B are diagrams illustrating examples related to generating predicted text using XR.

FIG. 5 is a diagram illustrating an example environment in which systems and/or methods described herein may be implemented.

FIG. 6 is a diagram of example components of one or more devices of FIG. 5.

FIGS. 7-8 are flowcharts of example processes relating to generating predicted text using XR.

### DETAILED DESCRIPTION

A user may compose a document having text in a variety of manners. In a first scenario, the user may handwrite text in a handwritten document (e.g., a piece of paper, which may be associated with a notepad, an envelope, or a birthday card) using a pen or pencil. In a second scenario, the user may electronically type text in an electronic document. For example, a computing device may run an application that supports creating and editing electronic documents. In both scenarios, the user may formulate the text that should be written in the document. The user may consult a reference, such as a book or an electronic page (e.g., a website), in order to get ideas for formulating the text. The user may sift through different references until a particular reference is of relevance, and based on an examination of that particular reference, the user may formulate the text that should be written in the document.

The user may spend an inordinate amount of time searching for relevant references. The user may need to look at each reference one-by-one, assess whether a particular reference is of interest, and then further examine that particular reference. When searching for relevant references, computing resources, network resources, and/or battery resources associated with a computing device used by the user may be wasted. With a vast number of references that are available, the user is limited in how many references are able to be found and analyzed. The user may often compose documents having similar text over time. If the user forgets exactly how certain text was worded in the past, the user may need to manually search for the previous text, which may consume additional time for the user. Further, searching for previous text may unnecessarily consume computing resources, network resources, and/or battery resources associated with the computing device used by the user.

Some applications may be available that provide text suggestions to users. For example, when a user is typing text in an application that executes on a computing device, the application may provide text suggestions. However, some users may prefer to not use such applications, and instead may prefer to compose documents by hand or using typewriters or other less-advanced technologies. Further, the text suggestions may be based on data collected from a plurality of users, and may not be tailored to an individual user's profile, text history, and writing style.

In some implementations described herein, to solve the problems described above, as well as the wasting of computing and network resources when searching online for related references, a solution is described herein for generating suggestions, such as predicted text, using extended reality (XR). An XR device may detect, using an image captured by a camera of the XR device, text associated with a document. The text may be handwritten text, and the document may be a handwritten document. Alternatively, the text may be electronic text, and the document may be an electronic document. The text associated with the document may be within a field of view of the camera of the XR device. In some cases, the XR device may detect a scene captured by the XR device, where the scene may be in a field of view of the XR device, and the XR device may detect the text associated with the document from the scene. The XR device may detect the scene when images are not captured to detect object/text in the scene. The XR device may determine, from the text, one or more keywords of the text and a context associated with the text. The XR device may generate, using a language model, predicted text based on the one or more keywords of the text and the context associated with the text. The predicted text may be related to the text associated with the document. In some cases, the XR device may offload the task of generating the predicted text to a server, since the server may have more advanced capabilities than the XR device (e.g., additional computing power for running complicated language models). The XR device may provide, via an interface of the XR device, the predicted text as a visual overlay to the text associated with the document. The predicted text may be visually overlayed in proximity to the text associated with the document. The user may see the text in the document in the real world. The XR device may electronically display the predicted text, which may be visually overlayed the text in the document in the real world. As a result, when the user is composing the document while wearing the XR device, the user may be presented with predicted text suggestions to aid the user when composing the document.

In some implementations, the XR device may generate, using the language model, a suggestion based on the one or more keywords of the text and the context associated with the text. The suggestion may be the predicted text. Alternatively, the suggestion may be a spelling or grammar correction, which may be based on the text associated with the document.

In some implementations, the XR device may visually present the predicted text when the user is composing the document, where the document may be the handwritten document or the electronic document. The predicted text may be tailored for the user. For example, the predicted text may be generated based on the user's past documents and/or writing style. The predicted text may be generated based on profile information about the user, such as the user's occupation, interest, demographic, etc. As a result, the user may not need to consult additional references for ideas when formulating text in the document. When the user appears to be composing text that has been used before (or is similar to text that has been used before), the XR device may provide predicted text that accounts for the previous text. As a result, the user may be reminded of text that has been used in the past. The user may use any medium (e.g., paper and pencil, a typewriter, or a basic text editor that runs on a computing device) to compose documents, and if the user is wearing the XR device, the user may be visually presented with the predicted text. As a result, the user may not be forced to use a certain application, and instead may use the medium in which the user is the most comfortable. The user may use a common predicted text feature across all document composition platforms, and may not need to use several individual predicted text features. For example, a first application may provide a first predictive text feature and a second application may provide a second predictive text feature. However, each predictive text feature may be slightly different and offer different predictive text suggestions. For example, each predictive text feature may consult different data sources and/or may be based on different algorithms, which may result in the predictive text being different across different applications. In this case, the common predicted text feature provided by the XR device may be tuned to the individual user and may be used across all of the document composition platforms.

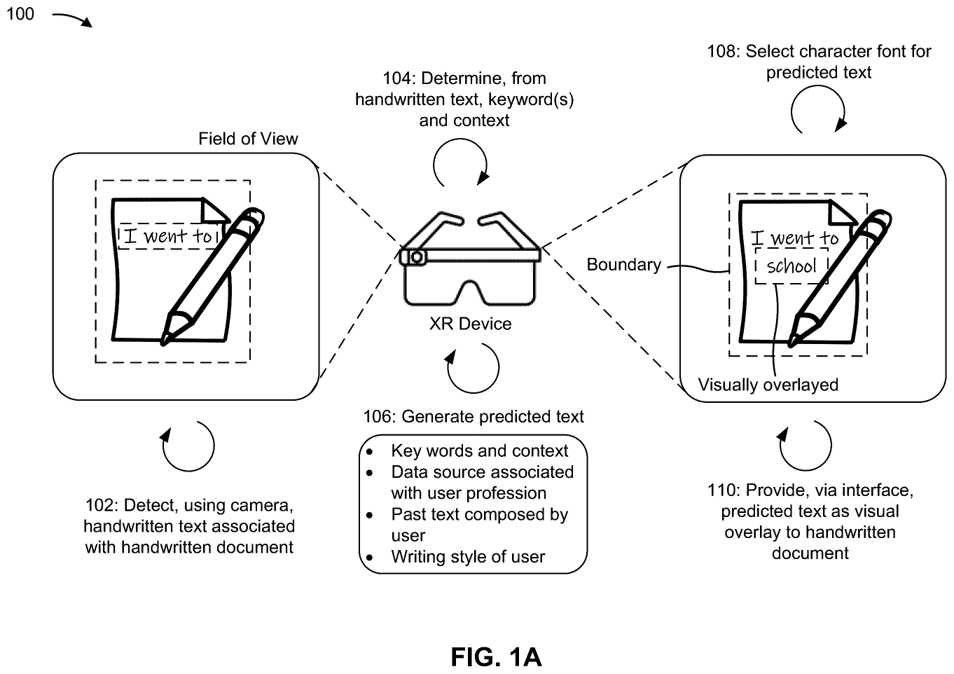

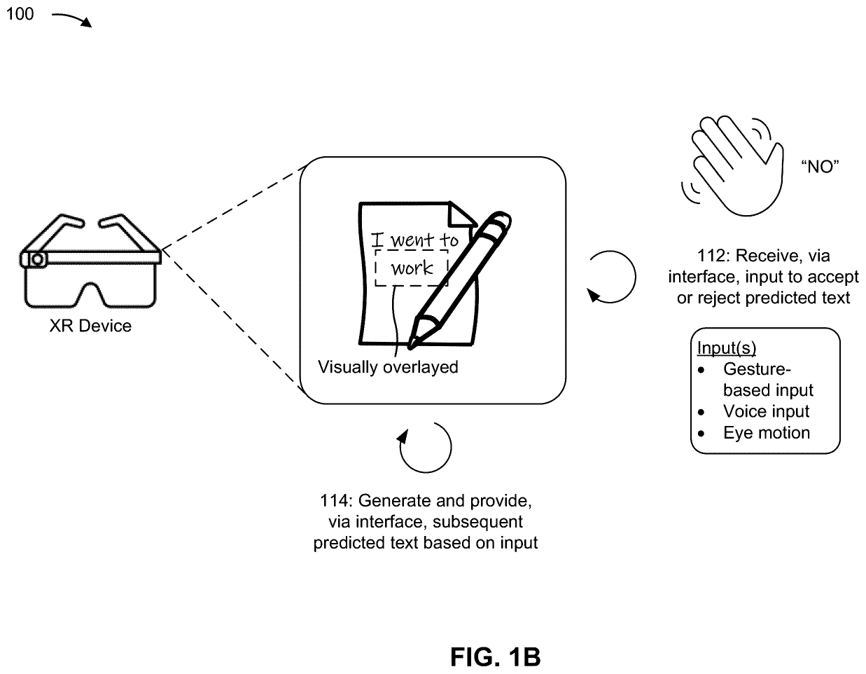

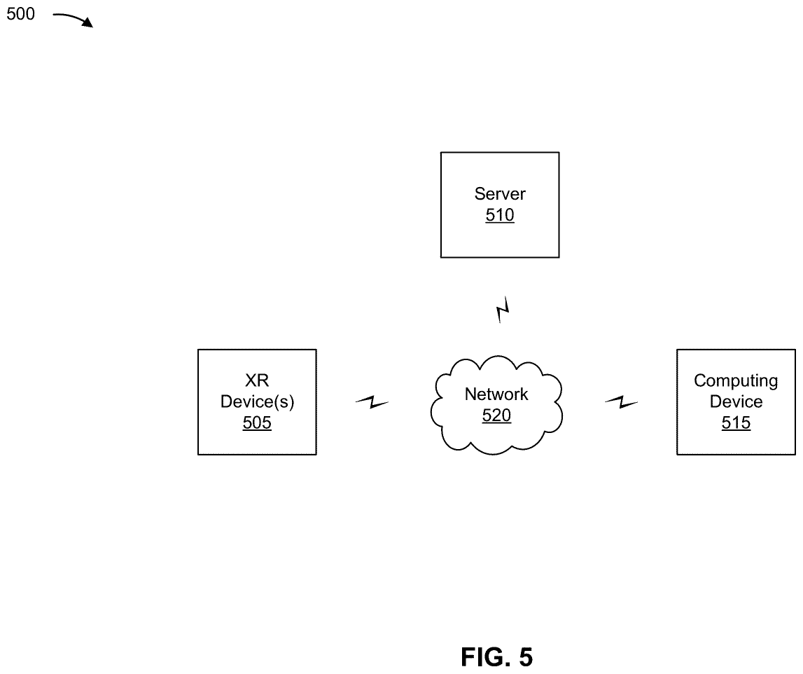

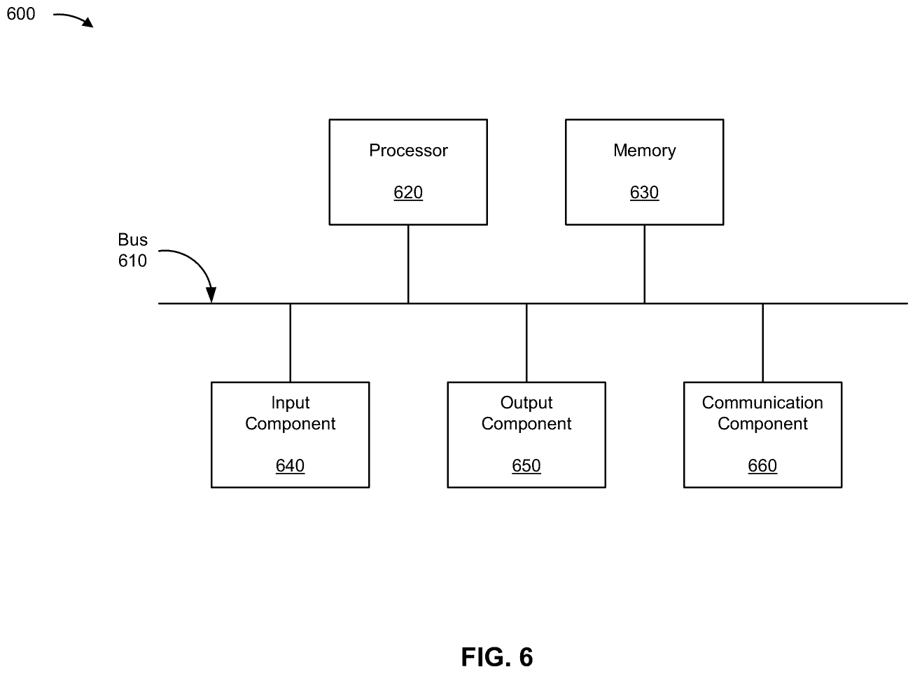

FIGS. 1A-1B are diagrams of an example 100 related to generating suggestions, such as predicted text, using XR. As shown in FIGS. 1A-1B, example 100 includes an XR device. This device is described in more detail in connection with FIGS. 5 and 6.

In some implementations, an XR device may be a head-mounted display worn by a user. Alternatively, the XR device may be a mobile device carried by the user. The XR device may provide augmented reality (AR), mixed reality (MR), and/or virtual reality (VR) capabilities. In some implementations, the server may be associated with a cloud computing system or an edge computing system. In some implementations, the social media platform may facilitate an exchange of information via social networks. “User”, “customer”, and “person” may be used interchangeably herein.

In some implementations, the XR device and/or a server which may communicate with the XR device may support a deep learning accelerator (DLA). The DLA may be a hardware architecture designed and optimized for increased speed, efficiency, and accuracy when running deep learning algorithms, such as convolutional neural networks (CNNs), recurrent neural networks (RNNs), generative adversarial networks (GANs), and others. The DLA may enable inference tasks to be performed more rapidly and using less energy as compared to general-purpose computers.

In some implementations, the DLA may by supported/used for processing and learning with respect to various tasks. Such tasks, which are further described herein, may include detecting, using a scene captured by the XR device, text associated with a document; determining keywords of the text and a context associated with the text; generating, using a language model, predicted text based on the keywords, the context; detecting, from the scene, a boundary associated with the document; determining a font corresponding to the text associated with the document; selecting a font for the predicted text; and/or determining an error associated with the text.

As shown in FIG. 1A, and by reference number 102, the XR device may detect, using an image captured by a camera of the XR device, handwritten text associated with a handwritten document. The handwritten text associated with the handwritten document may be within a field of view of the camera of the XR device. A user associated with the XR device may be composing the handwritten document. The user may be wearing the XR device when composing the handwritten document. The handwritten document may be associated with a letter, article, envelope, diary, prose, poetry, or essay. The XR device may capture the image and perform an image analysis on the image to determine that the handwritten text is in the image. The XR device may determine, via the camera, movements by the user that indicate that the user is writing (e.g., using a pen or pencil) the handwritten document. The handwritten document may be formed of paper or some other suitable material. In some implementations, the XR device may apply an optical character recognition (OCR) on the handwritten text, which may allow the XR device to recognize each character of the handwritten text. The XR device may identify an American Standard Code for Information Interchange (ASCII) code for each character in the handwritten text.

In some implementations, the XR device may detect, via the camera, the movement by the user indicating that the user is writing the handwritten document. The XR device may be triggered to capture the image based on the detected movement. In other words, the XR device may not capture images when the user associated with the XR device is not writing any handwritten document, thereby saving processing resources at the XR device.

In some implementations, the XR device may detect, from the image, multiple documents. The multiple documents may include handwritten documents and/or typed documents (e.g., documents that have been printed using a printer). The multiple documents may be next to each other. For example, the user may be consulting several typed documents when composing a handwritten document. The XR device may determine, using movement detected by the camera, which handwritten document is actively being modified by the user, and which documents are simply being read by the user. The XR device may determine the handwritten document that is actively being modified by the user, and then the XR device may detect the handwritten text associated with the handwritten document. The XR device may not detect text associated with documents that are not being actively modified by the user.

As shown by reference number 104, the XR device may determine, from the handwritten text (which has been subjected to OCR processing), one or more keywords of the handwritten text and a context associated with the handwritten text. The one or more keywords may correspond to words and/or phrases that capture an essence of the handwritten text (e.g., a theme associated with the handwritten text, a subject associated with the handwritten text, or an objective associated with the handwritten text). The context may provide contextual meaning to the handwritten text. For example, the context may provide information to better understand, evaluate, and/or interpret the ideas presented in the handwritten text. The context of a given word or phrase in the handwritten text may consist of words and/or phrases before and after the given word or phrase which provide clarity or meaning to the given word or phrase.

As shown by reference number 106, the XR device may generate, using a language model, predicted text based on the one or more keywords of the handwritten text and the context associated with the handwritten text. The predicted text may be related to the handwritten text associated with the handwritten document. The predicted text may be a word, a sentence, or a paragraph that is related to the handwritten text. The predicted text may be text that logically follows the handwritten text, such that the predicted text may logically be placed after the handwritten text and maintain a proper sentence flow and structure.

In some aspects, the XR device may generate, using the language model, a suggestion based on the one or more keywords of the handwritten text and the context associated with the handwritten text. The suggestion may be predictive text. Alternatively, the suggestion may be a spelling/grammar correction. The spelling/grammar correction may be associated with already written text. In other words, the XR device may provide a proofreading feature for the handwritten text.

In some implementations, the language model may be an attention-based language model deployed on the XR device. The language model may be a transformer-based machine learning model for natural language processing, such as Bidirectional Encoder Representations from Transformers (BERT). The language model may be an autoregressive language model that uses deep learning to produce human-like text, such as Generative Pre-trained Transformer (GPT). The language model that runs on the XR device may take the one or more keywords and the context as an input, and the language model may produce the predicted text as an output. The language model may be trained using supervised learning, unsupervised learning, or another suitable form of training.

In some implementations, the XR device may generate, using the language model, the predicted text to be personalized based on attributes of the user. The XR device may determine a user profile associated with the user. The user profile may indicate a profession of the user (e.g., a sports journalist or a celebrity gossip writer), an age of the user, an address of the user, and other demographic information associated with the user. The XR device may generate the predicted text using a data source that is associated with an attribute of the user, as indicated by the user profile. For example, the XR device may generate the predicted text using a data source that is associated with the profession of the user. If the profession of the user is a sports journalist, the data source may be articles related to sports. If the profession of the user is a celebrity gossip writer, the data source may be articles related to celebrities. As another example, the XR device may generate the predicted text using a data source that is associated with a city in which the user lives. The XR device may generate the predicted text based on past electronic pages (e.g., websites) visited by the user. The XR device may generate the predicted text based on previous text composed by the user. The XR device may generate the predicted text based on a writing style associated with the user (e.g., opinion, persuasive, reflective, personal, narrative, or descriptive). The XR device may be trained to generate predicted text using different types of writing styles. For example, the XR device may be trained on features that make predicted text have a persuasive writing style. As a result, the predicted text that is generated may be tailored to the individual user.

As shown by reference number 108, the XR device may determine, from the image and using object detection or a related technique, a font corresponding to the handwritten text associated with the handwritten document. The font may refer to a typography or text characters in a specific style and/or size. The XR device may determine the user's unique font style for each handwritten character in the handwritten document, as each individual user may write a letter or number in a certain manner. The XR device may determine a manner in which the user typically hand writes “A”, a manner in which the user typically hand writes “a”, and so on. The XR device may apply the same font corresponding to the handwritten text to the predicted text. In other words, the XR device may match a font style of the predicted text to the font style of the handwritten text.

As shown by reference number 110, the XR device may provide, via an interface of the XR device, the predicted text as a visual overlay to the handwritten text associated with the handwritten document. The predicted text may be projected as a visual suggestion onto a display of the XR device. The predicted text may be visually overlayed in proximity to the handwritten text associated with the handwritten document. The proximity may be determined using a sensor, such as a proximity sensor. Data from a proximity sensor, which may indicate a proximity between the user and the handwritten text, may be analyzed or manipulated to overlay the predicted text next to the handwritten text. For example, the XR device may display the predicted text in a manner so that the predicted text looks to appear after the handwritten text. The XR device may not project the predicted text onto another document that is not actively being modified by the user. The user wearing the XR device may see the handwritten text in the real world, and the user may see, via the XR device, an electronic display of the predicted text. The XR device may display the predicted text in the same font style associated with the handwritten text, such that the predicted text and the handwritten text may appear to be written by the same person. The XR device may generate the predicted text to have the same font style associated with the handwritten text based on the detected font associated with the handwritten text.

As an example, the user may be writing a note using a pen and pencil. The user may start writing “I went to”. The user may be wearing the XR device. The XR device may detect the text written by the user. The XR device may determine keywords and/or a theme associated with the text. The XR device may access data sources associated with a profile of the user, the user's past handwritten text (or handwritten documents), and/or writing style. The XR device may determine predicted text, using a language model and based on the keywords, theme, profile, past handwritten text, and/or writing style. The XR device may determine the predicted txt based on deep learning or related techniques. The XR device may classify handwritten words, perform natural language processing, etc. in order to determine the predicted text. In this example, the XR device may determine the predicted text to be “school”. The XR device may provide, via the interface, the word “school” as a text suggestion, where the word “school” may be visually overlayed on piece of paper. The word “school” may be placed right after the handwritten text of “I went to”. Further, the word “school” may be associated with a font style that corresponds to a font style of “I went to”.

In some implementations, the XR device may detect, from the image, a boundary associated with the handwritten document and an orientation associated with the handwritten document. The XR device may provide, via the interface, the predicted text as a visual overlay in proximity to the handwritten text associated with the handwritten document based on the boundary associated with the handwritten document and the orientation associated with the handwritten document. The XR device may not display predicted text that is outside of the boundary associated with the handwritten document. The XR device may display the predicted text with an orientation that matches the orientation associated with the handwritten document. For example, if the orientation associated with the handwritten document is slightly turned (e.g., based on how the user handwrites on the piece of paper while sitting at a desk), the XR device may display the predicted text with the same orientation. If the handwritten document moves while the user is handwriting, the display of the predicted text may be adjusted to match the orientation of the handwritten document.

As shown in FIG. 1B, and by reference number 112, the XR device may receive, via the interface, an input to accept the predicted text or reject (or ignore) the predicted text associated with the handwritten text. The input may be a gesture-based input. A gesture associated with the user may be a hand motion or a head motion. For example, the user may wave their hand or perform some other hand motion to accept the predicted text or reject the predicted text. The user may nod their head or shake their head to accept the predicted text or reject the predicted text, respectively. The input may be an eye motion of the user. For example, the eye motion may be an eye gaze or an eye blinking. In some implementations, the predicted text may disappear (e.g., the XR device may stop displaying the predicted text) based on the user writing the same predicted text in the handwritten document, or based on the user writing different text in the handwritten document. The XR device may detect the gesture of the user or the eye motion of the user using the camera. The input may be a voice input. For example, the user may issue a verbal command (e.g., yes or no) to accept the predicted text or reject the predicted text. The verbal command may indicate that the user is requesting another predicted text suggestion. The XR device may detect the verbal command using a microphone of the XR device. The XR device may perform a voice recognition to understand the verbal command issued by the user.

As shown by reference number 114, the XR device may generate subsequent predicted text based on the input (e.g., gesture-based input, voice input, and/or eye motion). The XR device may use the language model to generate the subsequent predicted text. The XR device may determine the subsequent predicted text using the keywords, theme, profile, past handwritten text, and/or writing style. Further, the XR device may determine the subsequent predicted text based on certain predicted text suggestions that were accepted or rejected by the user. When certain predicted text is rejected, the XR device may attempt to avoid similar predictive text in the future. On the other hand, when certain predicted text is accepted, the XR device may attempt to suggest similar predictive text in the future.

In some implementations, the XR device may implement an active learning-based approach, such that when the user contradicts a suggestion (e.g., predicted text) generated by the XR device, the XR device may use contradictory suggestions to further personalize subsequent predictive text presented to the user. The XR device may implement the active learning-based approach as a background process, and the active learning-based approach may assume that the user is the subject matter expert and that the user's input/actions take precedence over suggestions made by the XR device. As an example, the XR device may receive, via the interface, input from the user via hand motion or a verbal command. The input may indicate that the suggested word of “school” was rejected by the user. The XR device may use this input when generating subsequent predicted text (e.g., the word “work”).

In some implementations, the XR device may determine, from the image, an error associated with the handwritten text associated with the handwritten document. The error may be a spelling error or a grammatical error. The XR device may provide, via the interface, a suggestion to correct the error as a visual overlay to the text associated with the document. The suggestion may be visually overlayed in proximity to the handwritten text associated with the error. As a result, the user may be notified via the XR device of spelling or grammatical errors, and the user may fix such errors accordingly. The XR device may receive, via the interface, input to accept a recommended error correction (e.g., a spelling correction or a grammar correction) or reject the recommended error correction. Depending on the input, the XR device may adjust subsequent error suggestions accordingly.

In some implementations, the XR device may detect, using the camera, when the predictive text is written by the user. For example, the XR device may display a certain word as a visual overlay. The XR device may detect, using the camera, if the user writes the certain word or whether the user writes a different word. In either case, after the user write the certain word or the different word, the XR device may stop displaying the predictive text. When the XR device detects that the user writes the different word, the XR device may use the different word as an input when determining the subsequent predictive text.

As indicated above, FIG. 1 is provided as an example. Other examples may differ from what is described with regard to FIG. 1.

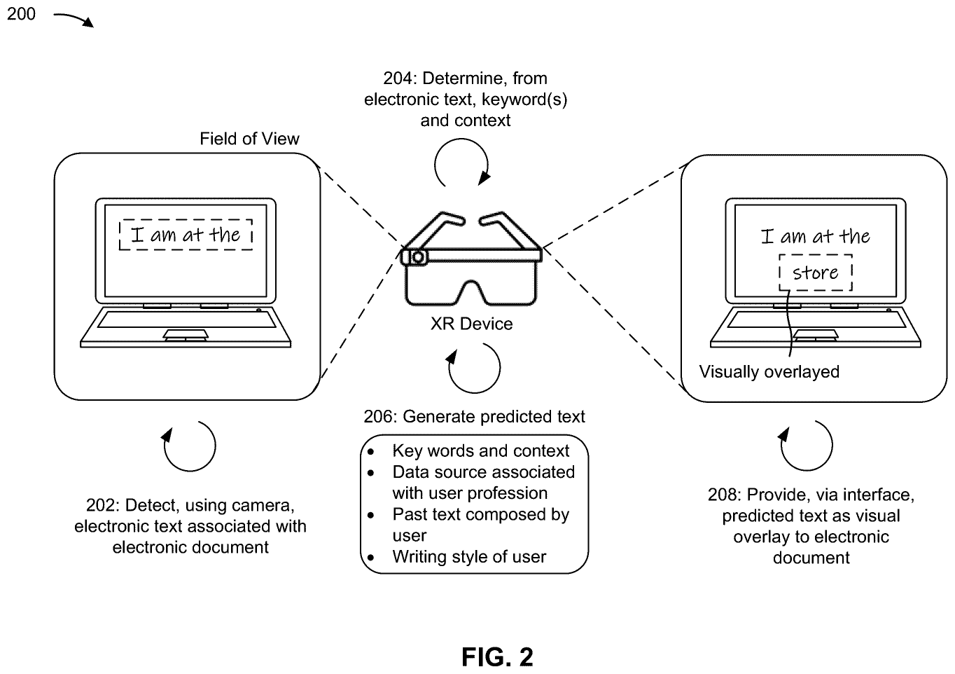

FIG. 2 is a diagram of an example 200 related to generating predicted text using XR. As shown in FIG. 2, example 200 includes an XR device. This device is described in more detail in connection with FIGS. 5 and 6.

As shown by reference number 202, the XR device may detect, using an image captured by a camera of the XR device, electronic text associated with an electronic document. The electronic text associated with the electronic document may be within a field of view of the camera of the XR device. A user wearing the XR device may be composing the electronic document via a computing device (e.g., a laptop). The computing device may execute an application to compose the electronic document. The computing device may display the electronic document with the electronic text. The electronic document may be associated with an email, article, blog, prose, poetry, or essay. The XR device may perform an image analysis on the image to determine that the electronic text is in the image. In some implementations, the XR device may apply an OCR to the electronic text in the image, which may allow the XR device to recognize each character of the electronic text.

In some implementations, the XR device may detect, via the camera, the movement by the user indicating that the user is composing the electronic text associated with the electronic document. The XR device may be triggered to capture the image based on the detected movement. In other words, the XR device may not capture images when the user associated with the XR device is not composing the electronic text associated with the electronic document, thereby saving processing resources at the XR device.

In some implementations, the XR device may detect, from the image, multiple documents. The multiple documents may include handwritten documents and/or electronic documents. The multiple documents may be next to each other. For example, the user may be consulting other electronic document (which may be displayed via the computing device) and/or handwritten documents. The XR device may determine, using movement detected by the camera, which electronic document is actively being modified by the user, and which documents are simply being read by the user. The XR device may determine the electronic document that is actively being modified by the user, and then the XR device may detect the electronic text associated with the electronic document. The XR device may not detect text associated with documents that are not being actively modified by the user.

As shown by reference number 204, the XR device may determine, from the electronic text (which has been subjected to OCR processing), one or more keywords of the electronic text and a context associated with the electronic text. The one or more keywords may correspond to words and/or phrases that capture an essence of the electronic text (e.g., a theme associated with the electronic text, a subject associated with the electronic text, or an objective associated with the electronic text). The context may provide contextual meaning to the electronic text. For example, the context may provide information to better understand, evaluate, and/or interpret the ideas presented in the electronic text. The context of a given word or phrase in the electronic text may consist of words and/or phrases before and after the given word or phrase which provide clarity or meaning to the given word or phrase.

As shown by reference number 206, the XR device may generate, using a language model, predicted text based on the one or more keywords of the electronic text and the context associated with the electronic text. The predicted text may be related to the electronic text associated with the electronic document. The predicted text may be a word, a sentence, or a paragraph that is related to the electronic text. The predicted text may be text that logically follows the electronic text, such that the predicted text may logically be placed after the electronic text and maintain a proper sentence flow and structure. In some implementations, the language model may be an attention-based language model deployed on the XR device. The language model may be a transformer-based machine learning model for natural language processing, such as BERT. The language model may be an autoregressive language model that uses deep learning to produce human-like text, such as GPT. The language model that runs on the XR device may take the one or more keywords and the context as an input, and the language model may produce the predicted text as an output.

In some aspects, the XR device may generate, using the language model, a suggestion based on the one or more keywords of the electronic text and the context associated with the electronic text. The suggestion may be predictive text. Alternatively, the suggestion may be a spelling/grammar correction. The spelling/grammar correction may be associated with already typed electronic text. In other words, the XR device may provide a proofreading feature for the electronic text.

In some implementations, the XR device may generate, using the language model, the predicted text to be personalized based on attributes of the user. The XR device may determine a user profile associated with the user. The user profile may indicate a profession of the user (e.g., a sports journalist), an age of the user, an address of the user, and other demographic information associated with the user. The XR device may generate the predicted text using a data source that is associated with an attribute of the user, as indicated by the user profile. The XR device may generate the predicted text based on past electronic pages (e.g., websites) visited by the user. The XR device may generate the predicted text based on previous text composed by the user. The XR device may generate the predicted text based on a writing style associated with the user (e.g., opinion, persuasive, reflective, personal, narrative, or descriptive). The XR device may be trained to generate predicted text using different types of writing styles. As a result, the predicted text that is generated may be tailored to the individual user.

In some implementations, the XR device may determine, from the image and by using image recognition or a related technique, a font corresponding to the electronic text associated with the electronic document. The XR device may compare one or more characters in the electronic text to a database of a plurality of different characteristics with corresponding fonts, which may allow the XR device to determine the font associated with the electronic text (e.g., Arial). The XR device may apply the same font corresponding to the electronic text to the predicted text. In other words, the XR device may match a font style of the predicted text to the font style of the electronic text.

As shown by reference number 208, the XR device may provide, via an interface of the XR device, the predicted text as a visual overlay to the electronic text associated with the electronic document. The predicted text may be projected as a visual suggestion onto a display of the XR device. The predicted text may be visually overlayed in proximity to the electronic text associated with the electronic document. The XR device may provide to the predicted text as the visual overlay to the electronic document that is being actively modified by the user, and not as a visual overlay to other electronic documents that are not being actively modified by the user. The XR device may display the predicted text in a manner so that the predicted text looks to appear after the electronic text. The user wearing the XR device may see the electronic text in the real world (e.g., on a screen of the computing device), and the user may see, via the XR device, an electronic display of the predicted text. The XR device may display the predicted text in the same font style associated with the electronic text. The XR device may generate the predicted text to have the same font style associated with the electronic text based on the detected font associated with the electronic text.

In some implementations, the XR device may detect, from the image, a boundary associated with the electronic document and an orientation associated with the electronic document. For example, the computing device may display multiple electronic documents, but the user may only be actively modifying one of the electronic documents. The XR device may distinguish the electronic document that is being actively modified from other electronic documents based on user hand motions and/or a cursor position (e.g., the cursor may hover over the electronic document that is being modified). The XR device may provide, via the interface, the predicted text as a visual overlay in proximity to the electronic text associated with the electronic document based on the boundary associated with the electronic document and the orientation associated with the electronic document. The XR device may not display predicted text that is outside of the boundary associated with the electronic document. The XR device may display the predicted text with an orientation that matches the orientation associated with the electronic document. If the electronic document moves while the user is composing the electronic text (e.g., the user moves a window associated with the electronic document, such that the electronic document is displayed on a different part of the screen), the display of the predicted text may be adjusted to match the orientation of the electronic document.

In some implementations, the XR device may receive, via the interface, an input to accept the predicted text or reject (or ignore) the predicted text associated with the electronic text. The input may be a gesture-based input. A gesture associated with the user may be a hand motion or a head motion. For example, the user may wave their hand or perform some other hand motion to accept the predicted text or reject the predicted text. The user may nod their head or shake their head to accept the predicted text or reject the predicted text, respectively. The input may be an eye motion of the user. For example, the eye motion may be an eye gaze or an eye blinking. In some implementations, the predicted text may disappear (e.g., the XR device may stop displaying the predicted text) based on the user composing (e.g., typing) the same predicted text in the electronic document, or based on the user composing different electronic text in the electronic document. The XR device may detect the gesture of the user or the eye motion of the user using the camera. The input may be a voice input. For example, the user may issue a verbal command (e.g., yes or no) to accept the predicted text or reject the predicted text. The verbal command may indicate that the user is requesting another predicted text suggestion. The XR device may detect the verbal command using a microphone of the XR device. The XR device may perform a voice recognition to understand the verbal command issued by the user.

In some implementations, the XR device may generate subsequent predicted text based on the input (e.g., gesture-based input, voice input, and/or eye motion). The XR device may use the language model to generate the subsequent predicted text. The XR device may determine the subsequent predicted text using the keywords, theme, profile, past composed electronic text, and/or writing style. Further, the XR device may determine the subsequent predicted text based on certain predicted text suggestions that were accepted or rejected by the user. When certain predicted text is rejected, the XR device may attempt to avoid similar predictive text in the future. On the other hand, when certain predicted text is accepted, the XR device may attempt to suggest similar predictive text in the future.

In some implementations, the XR device may determine, from the image, an error associated with the electronic text associated with the electronic document. The error may be a spelling error or a grammatical error. The XR device may provide, via the interface, a suggestion to correct the error as a visual overlay to the electronic text associated with the electronic document. The suggestion may be visually overlayed in proximity to the electronic text associated with the error. As a result, the user may be notified via the XR device of spelling or grammatical errors, and the user may fix such errors accordingly. The XR device may receive, via the interface, input to accept a recommended error correction (e.g., a spelling correction or a grammar correction) or reject the recommended error correction. Depending on the input, the XR device may adjust subsequent error suggestions accordingly.

In some implementations, the user may be composing the electronic text using an application executing on the computing device, where the application does not have a predictive text feature. In this case, the user may use the XR device to obtain the predictive text feature. Additionally, the user may use the same predictive text feature provided by the XR device when using different applications on the computing device. Since the predictive text feature provided by the XR device may be specially tailored to the user, the user may use the same predictive text feature for the different applications.

As indicated above, FIG. 2 is provided as an example. Other examples may differ from what is described with regard to FIG. 2.

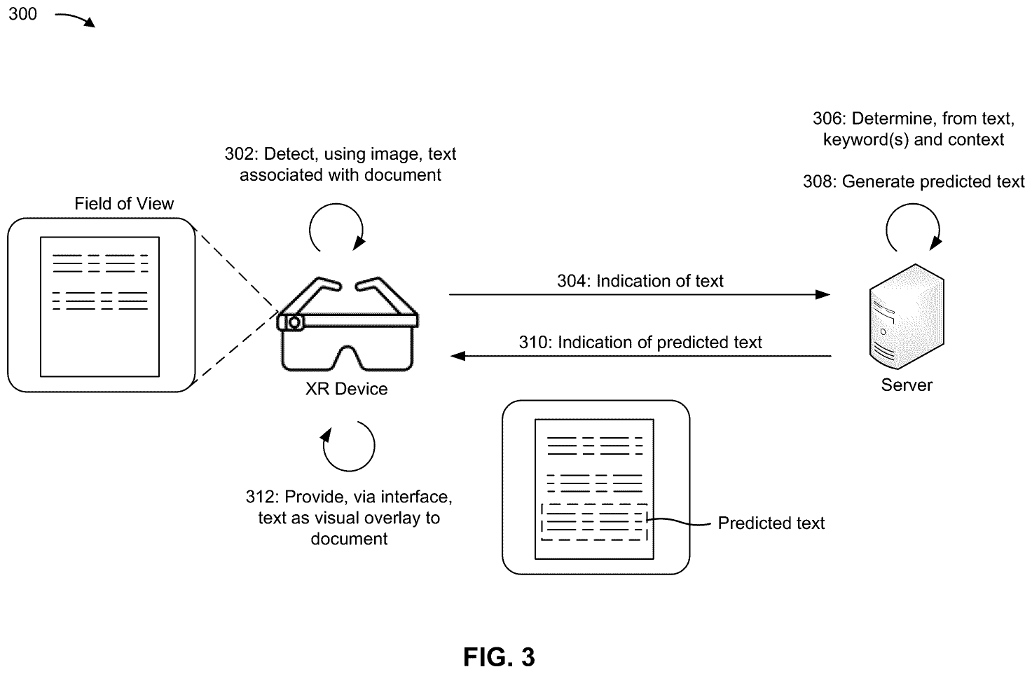

FIG. 3 is a diagram of an example 300 related to generating predicted text using XR. As shown in FIG. 3, example 300 includes an XR device and a server. The server may be associated with a cloud computing platform or an edge computing platform. These devices are described in more detail in connection with FIGS. 5 and 6.

As shown by reference number 302, the XR device may detect, using an image captured by a camera of an XR device, text associated with a document. The text associated with the document may be within a field of view of the camera of the XR device. The text may be associated with a word, a sentence, or a paragraph. The text may be handwritten text, and the document may be a handwritten document. Alternatively, the text may be electronic text, and the document may be an electronic document.

As shown by reference number 304, the XR device may transmit, to the server, an indication of the text. The indication may indicate the word, the sentence, or the paragraph associated with the document scanned by the camera of the XR device.

As shown by reference number 306, the server may determine, from the text, one or more keywords of the text and a context associated with the text. The one or more keywords may correspond to words and/or phrases that capture an essence of the text (e.g., a theme associated with the text, a subject associated with the text, or an objective associated with the text). The context may provide contextual meaning to the text.

As shown by reference number 308, the server may generate, using a language model, predicted text based on the one or more keywords of the text and the context associated with the text. The predicted text may be related to the text associated with the document. The predicted text may be a word, a sentence, or a paragraph that is related to the text. The server may be capable of running more complex language models as compared to the XR device, so in some cases, offloading the predicted text functionality to the server may result in more accurate predicted text. Further, offloading the predicted text functionality to the server may result in less resource consumption by the XR device.

As shown by reference number 310, the XR device may receive, from the server, an indication of predicted text related to the text associated with the document, where the predicted text may be based on the one or more keywords of the text and the context associated with the text. As shown by reference number 312, the XR device may provide, via the interface, the predicted text as a visual overlay to the text associated with the document. The predicted text may be visually overlayed next to the text associated with the document.

As indicated above, FIG. 3 is provided as an example. Other examples may differ from what is described with regard to FIG. 3.

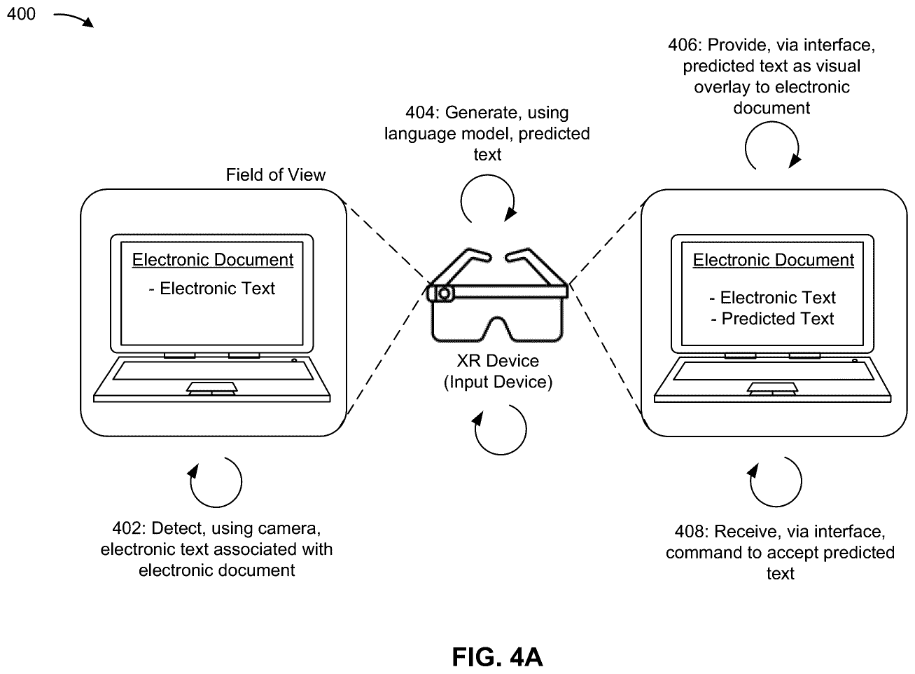

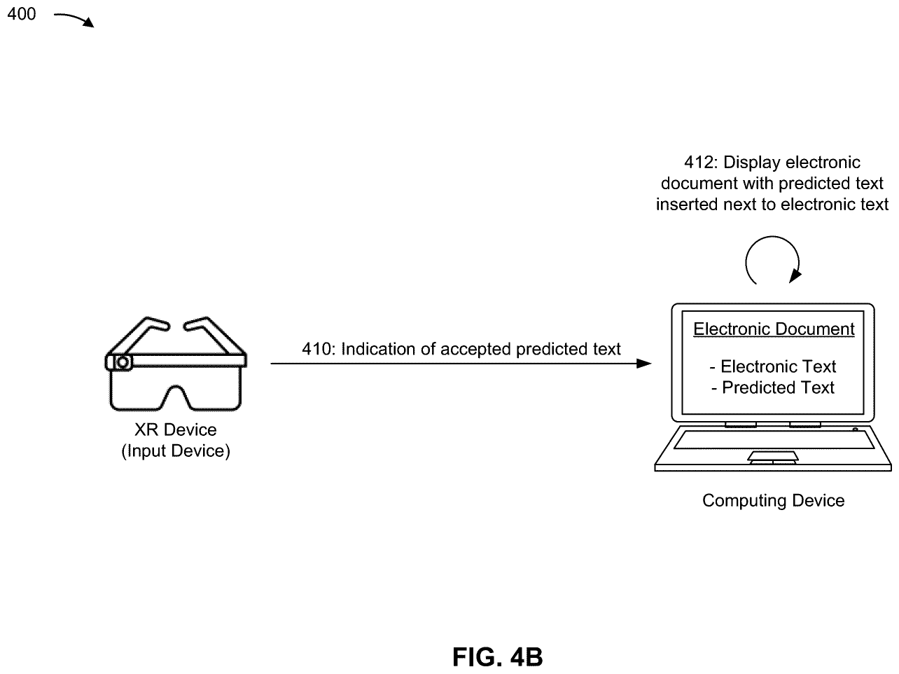

FIGS. 4A-4B are diagrams of an example 400 related to generating predicted text using XR. As shown in FIGS. 4A-4B, example 400 includes an XR device and a computing device. These devices are described in more detail in connection with FIGS. 5 and 6.

In some implementations, the XR device may serve as an input device to the computing device (e.g., similar to a keyboard and a mouse, which may serve as input devices to a desktop computer). The XR device may be connected to the computing device via a wired connection or via a wireless connection. The XR device may provide an interface that allows a user to use the XR device to compose an electronic document using an application that executes on the computing device. The interface associated with the XR device may allow the user to add words or phrases to the electronic document composed via the application running on the computing device.

As shown in FIG. 4A, and by reference number 402, the XR device may detect, using an image captured by a camera of the XR device, electronic text associated with the electronic document. The electronic text associated with the electronic document may be within a field of view of the camera of the XR device. A user wearing the XR device may be composing the electronic document via the computing device (e.g., a laptop). The computing device may display the electronic document with the electronic text. The electronic document may be associated with an email, article, blog, prose, poetry, or essay. The XR device may perform an image analysis on the image to determine that the electronic text is in the image. In some implementations, the XR device may apply an OCR to the electronic text in the image, which may allow the XR device to recognize each character of the electronic text.

As shown by reference number 404, the XR device may generate, using a language model, predicted text based on one or more keywords of the electronic text and a context associated with the electronic text. The one or more keywords may correspond to words and/or phrases that capture an essence of the electronic text (e.g., a theme associated with the electronic text, a subject associated with the electronic text, or an objective associated with the electronic text). The context may provide contextual meaning to the electronic text. The predicted text may be related to the electronic text associated with the electronic document. The predicted text may be a word, a sentence, or a paragraph that is related to the electronic text. The predicted text may be text that logically follows the electronic text, such that the predicted text may logically be placed after the electronic text and maintain a proper sentence flow and structure. In some implementations, the language model may be an attention-based language model deployed on the XR device. The language model may be a transformer-based machine learning model for natural language processing, such as BERT. The language model may be an autoregressive language model that uses deep learning to produce human-like text, such as GPT.

As shown by reference number 406, the XR device may provide, via an interface of the XR device, the predicted text as a visual overlay to the electronic text associated with the electronic document. The predicted text may be projected as a visual suggestion onto a display of the XR device. The predicted text may be visually overlayed in proximity to the electronic text associated with the electronic document. The XR device may display the predicted text in a manner so that the predicted text looks to appear after the electronic text. The user wearing the XR device may see the electronic text in the real world (e.g., on a screen of the computing device), and the user may see, via the XR device, an electronic display of the predicted text.

As shown by reference number 408, the XR device may receive, via the interface, an input to accept the predicted text associated with the electronic text. The input may be a gesture-based input. A gesture associated with the user may be a hand motion or a head motion. For example, the user may wave their hand or perform some other hand motion to accept the predicted text. The user may nod their head to accept the predicted text. The input may be an eye motion of the user. For example, the eye motion may be an eye gaze or an eye blinking. The XR device may detect the gesture of the user or the eye motion of the user using the camera. The input may be a voice input. For example, the user may issue a verbal command (e.g., yes) to accept the predicted text. The XR device may detect the verbal command using a microphone of the XR device. The XR device may perform a voice recognition to understand the verbal command issued by the user.

As shown by FIG. 4B, and by reference number 410, the XR device may transmit, to the computing device, an indication of the predicted text that has been accepted. In other words, the XR device may detect when predicted text has been accepted via the input (e.g., gesture-based input, voice input, and/or eye motion), and the XR device may send the indication of the accepted predicted text to the computing device.

As shown by reference number 412, the computing device may display, in the electronic document, the electronic text and the predicted text inserted next to the electronic text. The computing device may display the predicted text based on the indication received from the XR device. The XR device may display the predicted text in the same font style as the electronic text.

In some implementations, the user may wear the XR device when composing an electronic document having electronic text via the application running on the computing device. The application may not have a predictive text capability. The XR device may detect electronic text that the user has composed, and the XR device may generate text suggestions based on the electronic text. When the text suggestion is useful, the user may indicate (e.g., via gesture) to accept the text suggestion. The XR device may detect that the user has accepted the text suggestion, and the XR device may indicate the accepted text suggestion to the computing device. The computing device may insert the accepted text suggestion along with the electronic text already in the electronic document. As a result, the user may use the XR device as an input device when composing the electronic document via the computing device.

As indicated above, FIG. 4 is provided as an example. Other examples may differ from what is described with regard to FIG. 4.

FIG. 5 is a diagram of an example environment 500 in which systems and/or methods described herein may be implemented. As shown in FIG. 5, environment 300 may include an XR device 505, a server 510, a computing device 515, and a network 520. Devices of environment 500 may interconnect via wired connections, wireless connections, or a combination of wired and wireless connections.

An XR device 505 may be capable of receiving, generating, storing, processing, providing, and/or routing information associated with generating predicted text using XR, as described elsewhere herein. The XR device 505 may be a head-mounted device (or headset) or a mobile device. The XR device 505 may provide XR capabilities, which may include AR, MR, and/or VR. The XR device 505 may include various types of hardware, such as processors, sensors, cameras, input devices, and/or displays. The sensors may include accelerometers, gyroscopes, magnetometers, and/or eye-tracking sensors. The XR device 505 may include an optical head-mounted display, which may allow information to be superimposed onto a field of view.

The server 510 includes one or more devices capable of receiving, generating, storing, processing, providing, and/or routing information associated with generating predicted text using XR, as described elsewhere herein. The server 510 may include a communication device and/or a computing device. For example, the server 510 may be an application server, a client server, a web server, a database server, a host server, a proxy server, a virtual server (e.g., executing on computing hardware), or a server in a cloud computing system. In some implementations, the server 510 includes computing hardware used in a cloud computing environment. In some implementations, the server 510 may be part of a cloud computing system or an edge computing system.

The computing device 515 include one or more devices capable of receiving, generating, storing, processing, providing, and/or routing information associated with generating predicted text using XR, as described elsewhere herein. The computing device 515 may include a communication device and/or a computing device. For example, the computing device 515 may include a wireless communication device, a phone such as a smart phone, a mobile phone or video phone, user equipment, a laptop computer, a tablet computer, a desktop computer, or a similar type of device.

The network 520 includes one or more wired and/or wireless networks. For example, the network 520 may include a cellular network, a public land mobile network, a local area network, a wide area network, a metropolitan area network, a telephone network, a private network, the Internet, and/or a combination of these or other types of networks. The network 520 enables communication among the devices of environment 500.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of environment 500 may perform one or more functions described as being performed by another set of devices of environment 500.

FIG. 6 is a diagram of example components of a device 600 associated with generating predicted text using XR. Device 600 may correspond to XR device 505, server 510, and/or computing device 515. In some implementations, XR device 505, server 510, and/or computing device 515 may include one or more devices 600 and/or one or more components of device 600. As shown in FIG. 6, device 600 may include a bus 610, a processor 620, a memory 630, an input component 640, an output component 650, and a communication component 660.

Bus 610 may include one or more components that enable wired and/or wireless communication among the components of device 600. Bus 610 may couple together two or more components of FIG. 6, such as via operative coupling, communicative coupling, electronic coupling, and/or electric coupling. Processor 620 may include a central processing unit, a graphics processing unit, a microprocessor, a controller, a microcontroller, a digital signal processor, a field-programmable gate array, an application-specific integrated circuit, and/or another type of processing component. Processor 620 is implemented in hardware, firmware, or a combination of hardware and software. In some implementations, processor 620 may include one or more processors capable of being programmed to perform one or more operations or processes described elsewhere herein.

Memory 630 may include volatile and/or nonvolatile memory. For example, memory 630 may include random access memory (RAM), read only memory (ROM), a hard disk drive, and/or another type of memory (e.g., a flash memory, a magnetic memory, and/or an optical memory). Memory 630 may include internal memory (e.g., RAM, ROM, or a hard disk drive) and/or removable memory (e.g., removable via a universal serial bus connection). Memory 630 may be a non-transitory computer-readable medium. Memory 630 stores information, instructions, and/or software (e.g., one or more software applications) related to the operation of device 600. In some implementations, memory 630 may include one or more memories that are coupled to one or more processors (e.g., processor 620), such as via bus 610.

Input component 640 enables device 600 to receive input, such as user input and/or sensed input. For example, input component 640 may include a touch screen, a keyboard, a keypad, a mouse, a button, a microphone, a switch, a sensor, a global positioning system sensor, an accelerometer, a gyroscope, and/or an actuator. Output component 650 enables device 600 to provide output, such as via a display, a speaker, and/or a light-emitting diode. Communication component 660 enables device 600 to communicate with other devices via a wired connection and/or a wireless connection. For example, communication component 660 may include a receiver, a transmitter, a transceiver, a modem, a network interface card, and/or an antenna.

Device 600 may perform one or more operations or processes described herein. For example, a non-transitory computer-readable medium (e.g., memory 630) may store a set of instructions (e.g., one or more instructions or code) for execution by processor 620. Processor 620 may execute the set of instructions to perform one or more operations or processes described herein. In some implementations, execution of the set of instructions, by one or more processors 620, causes the one or more processors 620 and/or the device 600 to perform one or more operations or processes described herein. In some implementations, hardwired circuitry is used instead of or in combination with the instructions to perform one or more operations or processes described herein. Additionally, or alternatively, processor 620 may be configured to perform one or more operations or processes described herein. Thus, implementations described herein are not limited to any specific combination of hardware circuitry and software.

The number and arrangement of components shown in FIG. 6 are provided as an example. Device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

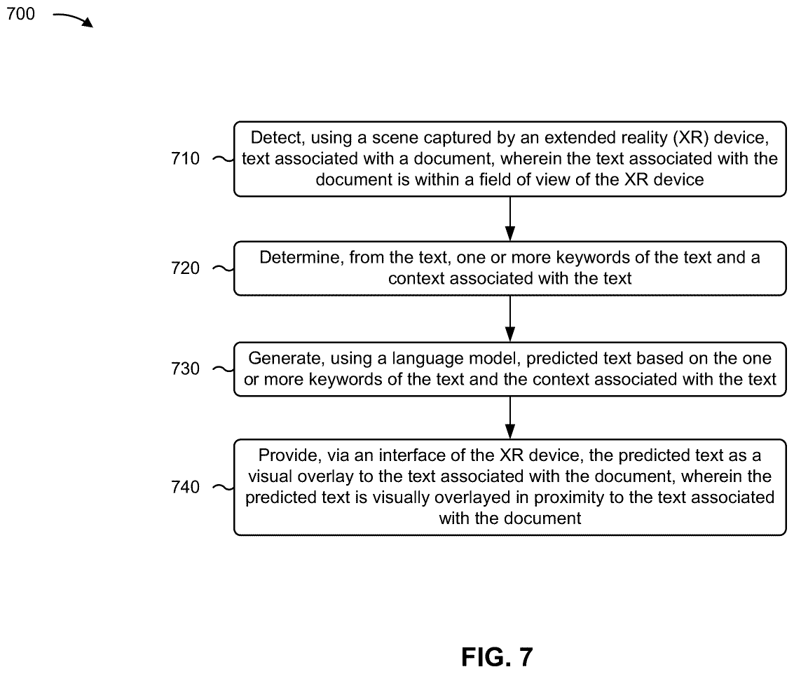

FIG. 7 is a flowchart of an example method 700 associated with generating predicted text using XR. In some implementations, an XR device (e.g., XR device 505) may perform or may be configured to perform one or more process blocks of FIG. 7. In some implementations, another device or a group of devices separate from or including the XR device (e.g., server 510) may perform or may be configured to perform one or more process blocks of FIG. 7. Additionally, or alternatively, one or more components of the XR device (e.g., processor 620, memory 630, input component 640, output component 650, and/or communication component 660) may perform or may be configured to perform one or more process blocks of FIG. 7.

As shown in FIG. 7, the method 700 may include detecting, using a scene captured by the XR device, text associated with a document, wherein the text associated with the document is within a field of view of the XR device (block 710). As further shown in FIG. 7, the method 700 may include determining, from the text, one or more keywords of the text and a context associated with the text (block 720). As further shown in FIG. 7, the method 700 may include generating, using a language model, predicted text based on the one or more keywords of the text and the context associated with the text (block 730). As further shown in FIG. 7, the method 700 may include providing, via an interface of the XR device, the predicted text as a visual overlay to the text associated with the document, wherein the predicted text is visually overlayed in proximity to the text associated with the document (block 740).

Although FIG. 7 shows example blocks of a method 700, in some implementations, the method 700 may include additional blocks, fewer blocks, different blocks, or differently arranged blocks than those depicted in FIG. 7. Additionally, or alternatively, two or more of the blocks of the method 700 may be performed in parallel. The method 700 is an example of one method that may be performed by one or more devices described herein. These one or more devices may perform or may be configured to perform one or more other methods based on operations described herein, such as the operations described in connection with FIGS. 1A-1B, 2-3, and 4A-4B.

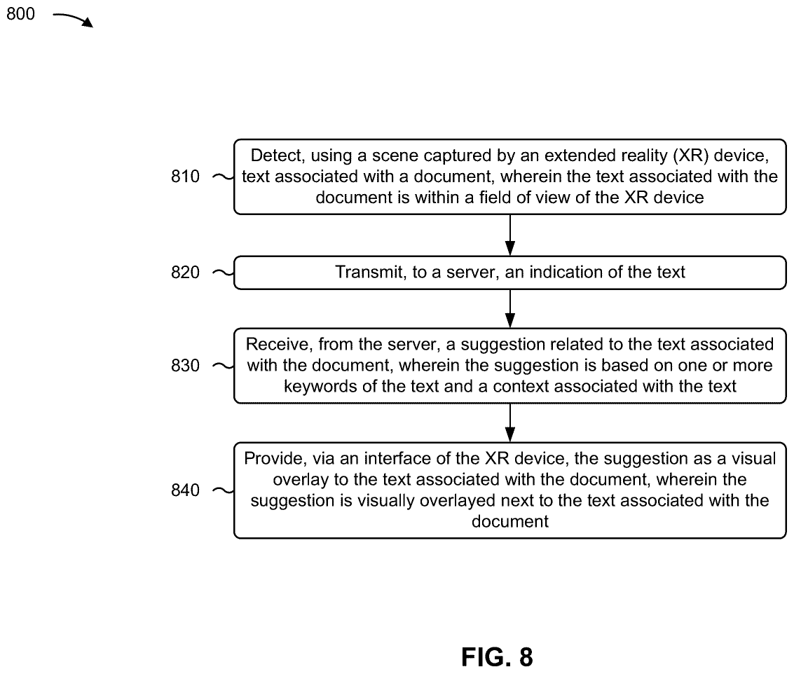

FIG. 8 is a flowchart of an example method 800 associated with generating predicted text using XR. In some implementations, an XR device (e.g., XR device 505) may perform or may be configured to perform one or more process blocks of FIG. 8. In some implementations, another device or a group of devices separate from or including the XR device (e.g., server 510) may perform or may be configured to perform one or more process blocks of FIG. 8. Additionally, or alternatively, one or more components of the XR device (e.g., processor 620, memory 630, input component 640, output component 650, and/or communication component 660) may perform or may be configured to perform one or more process blocks of FIG. 8.

As shown in FIG. 8, the method 800 may include detecting, using a scene captured by an XR device, text associated with a document, wherein the text associated with the document is within a field of view of the XR device (block 810). As further shown in FIG. 8, the method 800 may include transmitting, to a server, an indication of the text (block 820). As further shown in FIG. 8, the method 800 may include receiving, from the server, a suggestion related to the text associated with the document, wherein the suggestion is based on one or more keywords of the text and a context associated with the text (block 830). As further shown in FIG. 8, the method 800 may include providing, via an interface of the XR device, the suggestion as a visual overlay to the text associated with the document, wherein the suggestion is visually overlayed next to the text associated with the document (block 840).

Although FIG. 8 shows example blocks of a method 800, in some implementations, the method 800 may include additional blocks, fewer blocks, different blocks, or differently arranged blocks than those depicted in FIG. 8. Additionally, or alternatively, two or more of the blocks of the method 800 may be performed in parallel. The method 800 is an example of one method that may be performed by one or more devices described herein. These one or more devices may perform or may be configured to perform one or more other methods based on operations described herein, such as the operations described in connection with FIGS. 1A-1B, 2-3, and 4A-4B.

In some implementations, an extended reality (XR) device includes one or more components configured to: detect, using a scene captured by the XR device, text associated with a document, wherein the text associated with the document is within a field of view of the XR device; determine, from the text, one or more keywords of the text and a context associated with the text; generate, using a language model, predicted text based on the one or more keywords of the text and the context associated with the text; and provide, via an interface of the XR device, the predicted text as a visual overlay to the text associated with the document, wherein the predicted text is visually overlayed in proximity to the text associated with the document.

In some implementations, a method includes detecting, using a scene captured by an extended reality (XR) device, text associated with a document, wherein the text associated with the document is within a field of view of the XR device; transmitting, to a server, an indication of the text; receiving, from the server, predicted text related to the text associated with the document, wherein the predicted text is based on one or more keywords of the text and a context associated with the text; and providing, via an interface of the XR device, the predicted text as a visual overlay to the text associated with the document, wherein the predicted text is visually overlayed next to the text associated with the document.

In some implementations, a system includes a computing device comprising one or more components configured to: display an electronic document having electronic text; and an extended reality (XR) device configured to act as an input device for the computing device, the XR device comprising one or more components configured to: detect, using a scene captured by the XR device, the electronic text associated with the electronic document; generate, using a language model, a suggestion related to the electronic text associated with the electronic document; and provide, via an interface of the XR device, the suggestion as a visual overlay to the electronic text associated with the electronic document; receive, via the interface, a command to accept the suggestion; and transmit, to the computing device and based on the command, an indication of the suggestion for display via the computing device.

The foregoing disclosure provides illustration and description but is not intended to be exhaustive or to limit the implementations to the precise forms disclosed. Modifications and variations may be made in light of the above disclosure or may be acquired from practice of the implementations described herein.

The orientations of the various elements in the figures are shown as examples, and the illustrated examples may be rotated relative to the depicted orientations. The descriptions provided herein, and the claims that follow, pertain to any structures that have the described relationships between various features, regardless of whether the structures are in the particular orientation of the drawings, or are rotated relative to such orientation. Similarly, spatially relative terms, such as “below,” “beneath,” “lower,” “above,” “upper,” “middle,” “left,” and “right,” are used herein for ease of description to describe one element's relationship to one or more other elements as illustrated in the figures. The spatially relative terms are intended to encompass different orientations of the element, structure, and/or assembly in use or operation in addition to the orientations depicted in the figures. A structure and/or assembly may be otherwise oriented (rotated 90 degrees or at other orientations), and the spatially relative descriptors used herein may be interpreted accordingly. Furthermore, the cross-sectional views in the figures only show features within the planes of the cross-sections, and do not show materials behind the planes of the cross-sections, unless indicated otherwise, in order to simplify the drawings.

As used herein, the terms “substantially” and “approximately” mean “within reasonable tolerances of manufacturing and measurement.” As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

1. An extended reality (XR) device, comprising:
one or more components configured to:
detect movement by a user indicating that the user is composing a document;
detect, based on detecting the movement and using a scene captured by the XR device, text associated with the document, wherein the text associated with the document is within a field of view of the XR device;
determine, from the text, one or more keywords of the text and a context associated with the text;
determine a user profile of the user associated with the XR device, wherein the user profile indicates one or more attributes of the user;
generate, using a language model and one or more data sources respectively associated with the one or more attributes of the user, predicted text that is tailored to the user, wherein the predicted text is generated based on the one or more keywords of the text and the context associated with the text; and
provide, via an interface of the XR device, the predicted text as a visual overlay to the text associated with the document, wherein the predicted text is visually overlayed in proximity to the text associated with the document.

2. The XR device of claim 1, wherein the text is handwritten text, and wherein the document is a handwritten document.

3. The XR device of claim 1, wherein the text is electronic text, and wherein the document is an electronic document that is displayed using a computing device that is separate from the XR device.

4. The XR device of claim 1, wherein the one or more components are configured to:
detect, from the scene, a boundary associated with the document and an orientation associated with the document; and
provide, via the interface, the predicted text as a visual overlay in proximity to the text associated with the document based on the boundary associated with the document and the orientation associated with the document.

5. The XR device of claim 1, wherein the one or more components are configured to:
determine, using image recognition of an image associated with the scene, a font corresponding to the text associated with the document; and
select a font for the predicted text to match the font corresponding to the text associated with the document.

6. The XR device of claim 1, wherein the one or more components are configured to:
receive, via the interface, an input to accept the predicted text or reject the predicted text; and
generate subsequent predicted text based on the input.

7. The XR device of claim 6, wherein the input is a gesture-based input, wherein a gesture associated with the user of the XR device is a hand motion or a head motion.

8. The XR device of claim 6, wherein the input is a voice input.

9. The XR device of claim 6, wherein the input is an eye motion of the user associated with the XR device, wherein the eye motion is an eye gaze or an eye blinking.

10. The XR device of claim 1, wherein the XR device is an input device of a computing device and the document is displayed via the computing device, and wherein the one or more components are configured to:
receive, via the interface, an input to accept the predicted text, wherein the input is one of: a gesture-based input, a voice input, or an eye motion of the user associated with the XR device; and
transmit, to the computing device, an indication of the input to accept the predicted text, wherein the predicted text is inserted into the document displayed via the computing device.

11. The XR device of claim 1, wherein the one or more components are configured to:
generate the predicted text using one or more of past text composed by the user or a writing style associated with the user.

12. The XR device of claim 1, wherein the one or more components are configured to:
detect, between multiple documents, the document that is being composed by the user of the XR device; and
provide, via the interface, the predicted text as the visual overlay to the document that is being composed by the user and not to other documents of the multiple documents.

13. The XR device of claim 1, wherein the one or more components are configured to:
determine, from the scene, an error associated with the text associated with the document, wherein the error is one of a spelling error or a grammatical error; and
provide, via the interface, a suggestion to correct the error as a visual overlay to the text associated with the document, wherein the suggestion is visually overlayed in proximity to the text associated with the error.

14. A method, comprising:
detecting, by an extended reality (XR) device, movement by a user indicating that the user is composing a document:
detecting, based on detecting the movement and using a scene captured by the XR device, text associated with the document, wherein the text associated with the document is within a field of view of the XR device;
generating, using one or more data sources respectively associated with one or more attributes of the user associated with the XR device, predicted text that is tailored to the user and related to the text associated with the document, wherein the predicted text is based on one or more keywords of the text and a context associated with the text; and
providing, via an interface of the XR device, the predicted text as a visual overlay to the text associated with the document, wherein the predicted text is visually overlayed next to the text associated with the document.

15. The method of claim 14, wherein the text is handwritten text, and wherein the document is a handwritten document.

16. The method of claim 14, wherein the text is electronic text, and wherein the document is an electronic document that is displayed using a computing device that is separate from the XR device.

17. The method of claim 14, further comprising:
detecting, from the scene, a boundary associated with the document and an orientation associated with the document; and
providing, via the interface, the predicted text as a visual overlay next to the text associated with the document based on the boundary associated with the document and the orientation associated with the document.

18. The method of claim 14, further comprising:
determining, using image recognition of an image associated with the scene, a font corresponding to the text associated with the document; and
selecting a font for the predicted text to match the font corresponding to the text associated with the document.

19. The method of claim 14, further comprising:
receiving, via the interface, an input to accept the predicted text or reject the predicted text; and
providing, via the interface, subsequent predicted text as a visual overlay to the text associated with the document.

20. The method of claim 14, wherein the predicted text is derived using an attention based language model, wherein the attention based language model is one of: a transformer-based machine learning model for natural language processing, or an autoregressive language model that uses deep learning to produce human-like text.

21. The method of claim 14, wherein detecting the text associated with the document is based on an optical character recognition.

22. A system, comprising:
a computing device comprising one or more components configured to:
display an electronic document having electronic text; and
an extended reality (XR) device configured to act as an input device for the computing device, the XR device comprising one or more components configured to:
detect movement by a user indicating that the user is composing the electronic document;
detect, based on detecting the movement and using a scene captured by the XR device, the electronic text associated with the electronic document;
generate, using a language model and one or more data sources respectively associated with one or more attributes of the user associated with the XR device, a suggestion that is tailored to the user and related to the electronic text associated with the electronic document;
provide, via an interface of the XR device, the suggestion as a visual overlay to the electronic text associated with the electronic document;
receive, via the interface, a command to accept the suggestion; and
transmit, to the computing device and based on the command, an indication of the suggestion for display via the computing device.

23. The system of claim 22, wherein the one or more components of the computing device are configured to:
display the electronic document with the suggestion inserted next to the electronic text.

24. (canceled)

25. The system of claim 22, wherein the one or more components of the XR device are configured to:
detect, from the scene, a boundary associated with the electronic document; and
provide, via the interface, the suggestion as a visual overlay in proximity to the electronic text associated with the electronic document based on the boundary associated with the electronic document.

26. The system of claim 22, wherein the one or more attributes include at least one of: a profession of the user, an age of the user, an address of the user, or a city in which the user lives.
